(19) United States
(12) Patent Application Publication
(10) Pub. No.: US 2022/0120607 A1
(43) Pub. Date: Apr. 21, 2022

(54) OPTICAL FIBER SENSING SYSTEM, MONITORING APPARATUS, MONITORING METHOD, AND COMPUTER READABLE MEDIUM

(71) Applicant: NEC Corporation, Minato-ku, Tokyo (JP)

(72) Inventor: Takashi KOJIMA, Tokyo (JP)

(73) Assignee: NEC Corporation, Minato-ku, Tokyo (JP)

(21) Appl. No.: 17/428,179

(22) PCT Filed: Feb. 6, 2019
(86) PCT No.: PCT/JP2019/004217

§ 371 Date: Aug. 3, 2021

(51) Int. Cl. G01H 9/00; G08B 13/186

(52) U.S. Cl. CPC G01H 9/004; G08B 13/186

(57) ABSTRACT

An optical fiber sensing system according to this disclosure includes: a cable (20) including optical fibers; a reception unit (31) configured to receive, from at least one optical fiber included in the cable (20), an optical signal having a pattern in accordance with a state of a target to be monitored; and a monitoring unit (32) configured to specify the location of the target to be monitored based on the pattern that the optical signal has and specify the trajectory of the target to be monitored based on a locational variation of the specified location.

### TECHNICAL FIELD

The present disclosure relates to an optical fiber sensing system, a monitoring apparatus, a monitoring method, and a computer readable medium.

### BACKGROUND ART

Monitoring of targets to be monitored (mainly, persons) have often been performed by cameras.

Patent Literature 1 discloses, for example, a technique of selecting, when a point at which an abnormality has occurred is specified, one of a plurality of cameras that can capture an image of this point, determining the photographing direction of the selected camera, and performing turning control of the camera in such a way that this camera is directed to the determined photographing direction.

### CITATION LIST

### Patent Literature

### [Patent Literature 1] Japanese Unexamined Patent Application Publication No. 2005-136774

### SUMMARY OF INVENTION

### Technical Problem

However, the monitoring areas monitored by cameras are limited to the areas in which the cameras are installed. Further, when, in particular, cameras are required to have high resolution in order to achieve image recognition of camera images, a camera arrangement in which the monitoring area for each camera is narrowed down is required. When, for example, a wide monitoring area such as a border or a place in the vicinity of an airport is monitored by cameras, if the cameras are provided so as to cover the entire wide monitoring area, the number of cameras and the cost for monitoring become enormous.

An object of the present disclosure is to provide an optical fiber sensing system, a monitoring apparatus, a monitoring method, and a computer readable medium capable of solving the aforementioned problems and constructing a system capable of continuously tracking the target to be monitored.

### Solution to Problem

An optical fiber sensing system according to one aspect includes:

a cable including optical fibers;

a reception unit configured to receive, from at least one optical fiber included in the cable, an optical signal having a pattern in accordance with a state of a target to be monitored; and

a monitoring unit configured to specify the location of the target to be monitored based on the pattern that the optical signal has and specify the trajectory of the target to be monitored based on a locational variation of the specified location.

A monitoring apparatus according to one aspect includes:

a reception unit configured to receive, from at least one optical fiber included in a cable, an optical signal having a pattern in accordance with a state of a target to be monitored; and

a monitoring unit configured to specify the location of the target to be monitored based on the pattern that the optical signal has and specify the trajectory of the target to be monitored based on a locational variation of the specified location.

A monitoring method according to one aspect includes:

receiving, from at least one optical fiber included in a cable, an optical signal having a pattern in accordance with a state of a target to be monitored; and

specifying the location of the target to be monitored based on the pattern that the optical signal has and specifying the trajectory of the target to be monitored based on a locational variation of the specified location.

A non-transitory computer readable medium according to one aspect stores a program for causing a computer to execute the following procedures of:

receiving, from at least one optical fiber included in a cable, an optical signal having a pattern in accordance with a state of a target to be monitored; and

specifying the location of the target to be monitored based on the pattern that the optical signal has and specifying the trajectory of the target to be monitored based on a locational variation of the specified location.

### Advantageous Effects of Invention

According to the aforementioned aspects, it is possible to obtain an effect that an optical fiber sensing system, a monitoring apparatus, a monitoring method, and a computer readable medium capable of constructing a system capable of continuously tracking the target to be monitored can be provided.

### BRIEF DESCRIPTION OF DRAWINGS

FIG. 1 is a diagram showing a configuration example of an optical fiber sensing system according to a first embodiment;

FIG. 2 is a diagram showing an example of vibration data acquired by an optical fiber detection unit according to the first embodiment;

FIG. 3 is a diagram showing an example in which the vibration data acquired by the optical fiber detection unit according to the first embodiment is arranged in time series;

FIG. 4 is a diagram showing an example in which a monitoring unit according to the first embodiment tracks a target to be monitored;

FIG. 5 is a block diagram showing an example of a hardware configuration of a computer that implements a monitoring apparatus according to the first embodiment;

FIG. 6 is a flowchart showing an example of an operation flow of the optical fiber sensing system according to the first embodiment;

FIG. 7 is a diagram showing an example of specific operations of a monitoring unit according to the first embodiment;

FIG. 8 is a diagram showing a configuration example of an optical fiber sensing system according to a second embodiment;

FIG. 9 is a diagram showing an example in which a monitoring unit according to the second embodiment tracks a target to be monitored;

FIG. 10 is a diagram showing another example in which the monitoring unit according to the second embodiment tracks the target to be monitored;

FIG. 11 is a diagram showing one more example in which the monitoring unit according to the second embodiment tracks the target to be monitored;

FIG. 12 is a flowchart showing an example of an operation flow of the optical fiber sensing system according to the second embodiment;

FIG. 13 is a diagram showing a configuration example of an optical fiber sensing system according to a third embodiment;

FIG. 14 is a diagram showing a display example of results of tracking a target to be monitored by a display unit according to the third embodiment;

FIG. 15 is a diagram showing another display example of the results of tracking the target to be monitored by the display unit according to the third embodiment;

FIG. 16 is a diagram showing one more display example of the results of tracking the target to be monitored by the display unit according to the third embodiment;

FIG. 17 is a diagram showing one more display example of the results of tracking the target to be monitored by the display unit according to the third embodiment;

FIG. 18 is a diagram showing one more display example of the results of tracking the target to be monitored by the display unit according to the third embodiment;

FIG. 19 is a diagram showing one more display example of the results of tracking the target to be monitored by the display unit according to the third embodiment;

FIG. 20 is a diagram showing one more display example of the results of tracking the target to be monitored by the display unit according to the third embodiment; and

FIG. 21 is a flowchart showing an example of an operation flow of the optical fiber sensing system according to the third embodiment.

### DESCRIPTION OF EMBODIMENTS

Hereinafter, with reference to the drawings, embodiments of the present disclosure will be explained.

### First Embodiment

### <Configuration of First Embodiment>

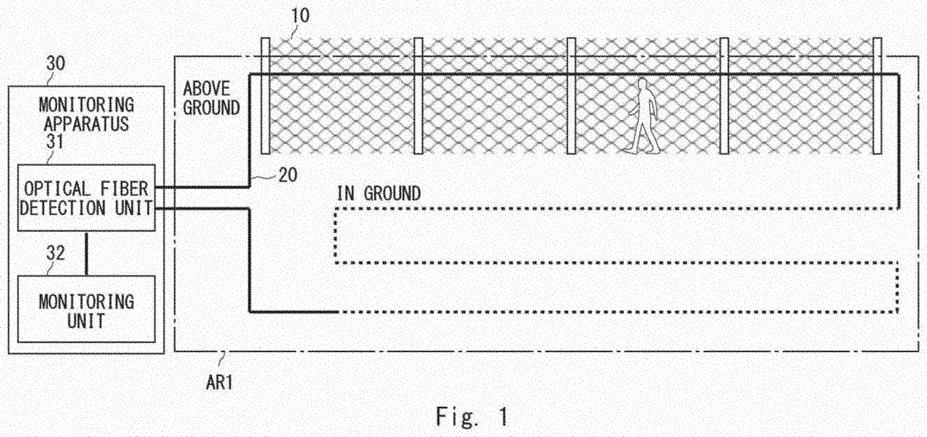

Referring first to FIG. 1, a configuration of an optical fiber sensing system according to a first embodiment will be explained. While the targets to be monitored are described as being persons who are in a fence 10 and in the vicinity thereof in the first embodiment, the target to be monitored is not limited thereto.

As shown in FIG. 1, the optical fiber sensing system according to the first embodiment, which tracks the targets to be monitored who are in the fence 10 and in the vicinity thereof, includes an optical fiber cable 20 and a monitoring apparatus 30. Further, the monitoring apparatus 30 includes an optical fiber detection unit 31 and a monitoring unit 32. Further, the optical fiber detection unit 31 is one example of a reception unit.

The optical fiber cable 20, which is a cable configured to coat one or more optical fibers, is laid continuously in the fence 10 above the ground, and in the ground in the vicinity of the fence 10, and the respective ends of the optical fiber cable 20 are connected to the optical fiber detection unit 31. In FIG. 1, the part of the optical fiber cable 20 laid above the ground is shown by a solid line and the part of the optical fiber cable 20 laid in the ground is shown by a dotted line. However, the method of laying the optical fiber cable 20 shown in FIG. 1 is merely one example, and it is not limited thereto. For example, the optical fiber cable 20 may be laid down in the whole part of an optical fiber sensing area AR1 in which optical fiber sensing (tracking of the target to be monitored based on the pattern detection, which will be described later) is performed regardless of whether it is above the ground or in the ground.

The optical fiber detection unit 31 emits a pulsed light to at least one optical fiber included in the optical fiber cable 20. Further, the optical fiber detection unit 31 receives a reflected light or a scattered light generated while the pulsed light is being transmitted through the optical fiber as a return light via the same optical fiber. In FIG. 1, the optical fiber detection unit 31 emits the pulsed light in the clockwise direction and receives the return light with respect to this pulsed light from the clockwise direction. At the same time, the optical fiber detection unit 31 emits a pulsed light in the counterclockwise direction and receives a return light with respect to this pulsed light from the counterclockwise direction. That is, the optical fiber detection unit 31 receives the return light from two directions.

When a vibration occurs in the fence 10 and in the vicinity thereof, this vibration is superimposed on the return light transmitted by the optical fiber. Therefore, the optical fiber detection unit 31 is able to detect the vibration that has occurred in the fence 10 and in the vicinity thereof based on the received return light. Further, the optical fiber detection unit 31 is able to detect, based on the time from when the pulsed light is input to the optical fiber to when the return light on which the vibration is superimposed is received, the location where this vibration has occurred (the distance from the optical fiber detection unit 31).

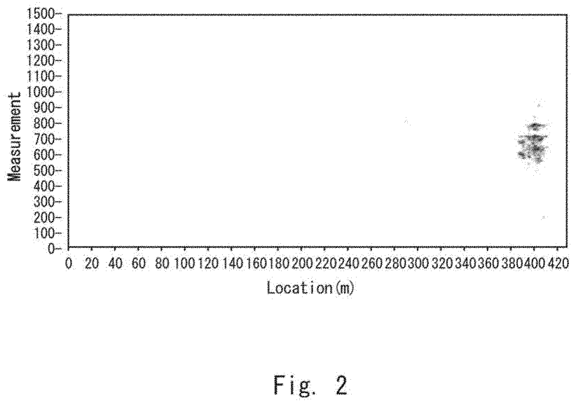

For example, the optical fiber detection unit 31 detects the received return light by a distributed vibration sensor, whereby the optical fiber detection unit 31 is able to detect the vibration that has occurred in the fence 10 and in the vicinity thereof and the location where this vibration has occurred, and to acquire vibration data of the vibration that has occurred in the fence 10 and in the vicinity thereof. For example, FIG. 2 shows an example of the vibration data of the vibration that has occurred in the fence 10 and in the vicinity thereof, in which the horizontal axis indicates the location (distance from the optical fiber detection unit 31) and the vertical axis indicates the passage of time. In the example shown in FIG. 2, the vibration occurs in a position that is located about 400 m away from the optical fiber detection unit 31.

Now, the vibration data of the vibration that has occurred in the fence 10 and in the vicinity thereof detected by the optical fiber detection unit 31 has its unique pattern in which the transition of fluctuation in the strength of the vibration, the location of the vibration, the number of vibrations and the like differs from one another depending on the states of the persons who are in the fence 10 and in the vicinity thereof.

Therefore, the monitoring unit 32 is able to specify the location of the target to be monitored who are in the fence 10 and in the vicinity thereof by analyzing the dynamic change of the unique pattern that the vibration data has and to specify the trajectory of this person by analyzing the locational variation of the same person. Further, the monitoring unit 32 may predict the location to which the target to be monitored will move next based on the specified trajectory of the target to be monitored.

Further, the monitoring unit 32 is able to specify the actions that the targets to be monitored who are in the fence 10 and in the vicinity thereof have taken in the location specified above by analyzing the dynamic change of the unique pattern that the vibration data has. The persons who are in the fence 10 and in the vicinity thereof may take, for example, the following actions.

(1) grab and shake the fence 10
(2) hit the fence 10
(3) climb the fence 10
(4) set up a ladder against the fence 10 and climb up the ladder
(5) hang around the fence 10
(6) dig a hole near the fence 10
(7) fire a gun near the fence 10
(8) put something near the fence 10

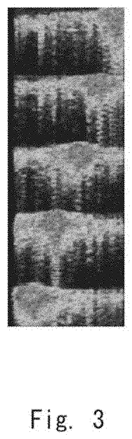

For example, the vibration data indicating that the target to be monitored moves while hitting the fence 10 and eventually digs a hole in the vicinity of the fence 10 is as shown in FIG. 3. The vibration data shown in FIG. 3 is vibration data similar to the vibration data shown in FIG. 2 arranged vertically in time series.

Now, a method of specifying the actions of the targets to be monitored who are in the fence 10 and the vicinity thereof in the monitoring unit 32 based on the vibration data of the vibration that has occurred in the fence 10 and the vicinity thereof may be, for example, a method of using pattern matching. In the following description, one example of the pattern matching will be explained.

The monitoring unit 32 learns, in advance, for example, a unique pattern that the vibration data of the vibration that is occurred when a person takes one of the aforementioned actions (1) to (8) in the fence 10 and the vicinity thereof has. The learning method may be machine learning, but it is not limited thereto.

When the monitoring unit 32 specifies the actions of the targets to be monitored who are in the fence 10 and in the vicinity thereof, it first acquires the vibration data from the optical fiber detection unit 31. Then the monitoring unit 32 performs pattern matching of the pattern that the vibration data acquired from the optical fiber detection unit 31 has and the pattern that the vibration data learned in advance has, thereby specifying the actions of the targets to be monitored who are in the fence 10 and in the vicinity thereof.

Further, a sound and the temperature generated in the fence 10 and in the vicinity thereof are also superimposed on the return light transmitted by the optical fiber. Therefore, the optical fiber detection unit 31 is able to detect the sound and the temperature generated in the fence 10 and in the vicinity thereof as well based on the received return light.

The optical fiber detection unit 31 detects, for example, the received return light by a distributed acoustic sensor and a distributed temperature sensor, whereby the optical fiber detection unit 31 is able to detect the sound and the temperature occurred in the fence 10 and in the vicinity thereof and acquire acoustic data and temperature data of the sound and the temperature occurred in the fence 10 and in the vicinity thereof. In addition thereto, the optical fiber detection unit 31 is able to detect distortion/stress occurred in the fence 10 and in the vicinity thereof and acquire distortion/stress data. Further, the acoustic data, the temperature data, and the distortion/stress data described above also have a unique pattern in accordance with the actions of the targets to be monitored who are in the fence 10 and the vicinity thereof.

Therefore, the monitoring unit 32 may specify the trajectory and the action of the person with a higher accuracy and specify a more complex action of the person by analyzing not only the unique pattern of the vibration that has occurred in the fence 10 and the vicinity thereof but also a dynamic change in a composite unique pattern including a unique pattern of a sound, temperature, distortion/stress or the like.

Now, an example in which the monitoring unit 32 tracks the target to be monitored in the first embodiment will be explained.

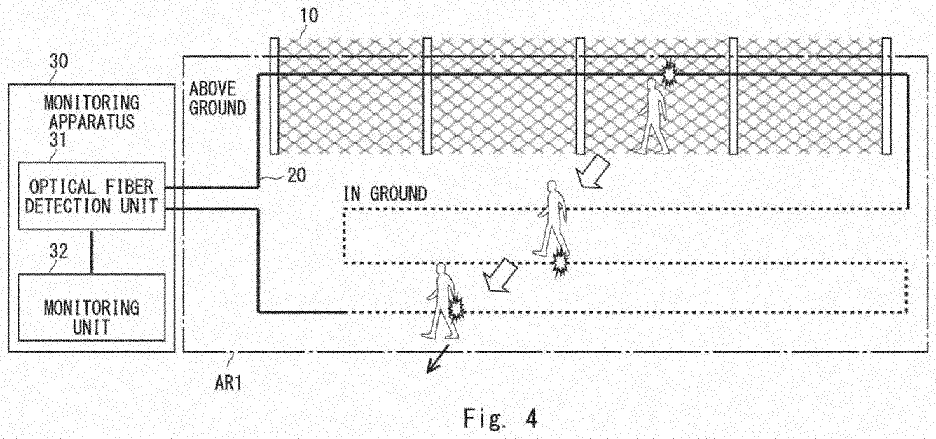

Assume a case in which, for example, the target to be monitored has moved inside the optical fiber sensing area AR1, as shown in FIG. 4. In this case, the monitoring unit 32 specifies each of the locations to which the target to be monitored has moved based on the pattern that the return light received in the optical fiber detection unit 31 has, and specifies the trajectory of the target to be monitored based on the locational variation of the specified location. Further, the monitoring unit 32 also specifies the action that the target to be monitored has taken in the aforementioned specified location based on the pattern that the return light has.

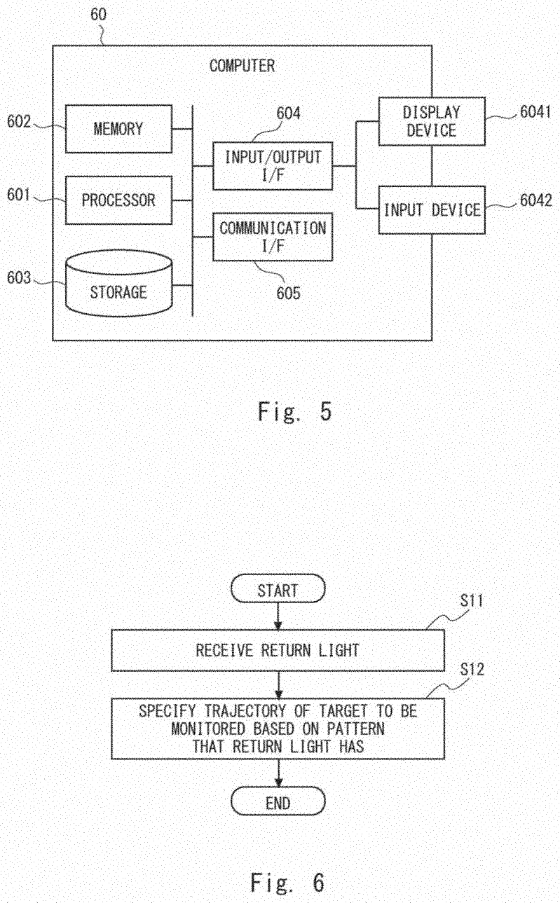

In the following description, with reference to FIG. 5, a hardware configuration of a computer 60 implementing the monitoring apparatus 30 will be explained.

As shown in FIG. 5, the computer 60 includes a processor 601, a memory 602, a storage 603, an input/output interface (input/output I/F) 604, a communication interface (communication I/F) 605 and the like. The processor 601, the memory 602, the storage 603, the input/output interface 604, and the communication interface 605 are connected by a data transmission path for transmitting and receiving data between them.

The processor 601 is, for example, an operation processing apparatus such as a Central Processing Unit (CPU) or a Graphics Processing Unit (GPU). The memory 602 is, for example, a memory such as a Random Access Memory (RAM) or a Read Only Memory (ROM). The storage 603 is a storage device such as a Hard Disk Drive (HDD), a Solid State Drive (SSD), or a memory card. Further the storage 603 may be a memory such as a RAM or a ROM.

The storage 603 stores programs for achieving functions of the optical fiber detection unit 31 and the monitoring unit 32 included in the monitoring apparatus 30. The processor 601 executes these programs, thereby achieving the functions of the optical fiber detection unit 31 and the monitoring unit 32. When executing these programs, the processor 601 may load these programs on the memory 602 and then execute these loaded programs or may execute these programs without loading them on the memory 602. Further, the memory 602 and the storage 603 also serve to store information and data held in the optical fiber detection unit 31 and the monitoring unit 32.

Further, the program(s) can be stored and provided to a computer (including the computer 60) using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc-ROM (CD-ROM), CD-Recordable (CD-R), CD-ReWritable (CD-R/W), and semiconductor memories (such as mask ROM, Programmable ROM (PROM), Erasable PROM (EPROM), flash ROM, RAM, etc.). Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The input/output interface 604 is connected to a display device 6041, an input device 6042 or the like. The display device 6041 is a device that displays a screen that corresponds to drawing data processed by the processor 601 such as a Liquid Crystal Display (LCD) or a Cathode Ray Tube (CRT) display. The input device 6042, which is a device that receives an operation input by an operator, is, for example, a keyboard, a mouse, and a touch sensor. The display device 6041 and the input device 6042 may be integrated and may be provided as a touch panel. The computer 60, which may include a sensor (not shown) such as a distributed vibration sensor, may include a configuration in which this sensor is connected to the input/output interface 604.

The communication interface 605 transmits and receives data to and from an external apparatus. The communication interface 605 communicates, for example, with an external apparatus via a wired communication path or a wireless communication path.

### <Operations of First Embodiment>

Hereinafter, with reference to FIG. 6, an operation flow of the optical fiber sensing system according to this first embodiment will be explained.

As shown in FIG. 6, first, the optical fiber detection unit 31 emits the pulsed light to at least one optical fiber included in the optical fiber cable 20 and receives the return light having a pattern in accordance with the states of the targets to be monitored who are in the fence 10 and in the vicinity thereof from the optical fiber the same as the optical fiber to which the pulsed light has been emitted (Step S11).

After that, the monitoring unit 32 specifies the location of the target to be monitored based on the pattern that the return light has and specifies the trajectory of the target to be monitored based on the locational variation of the specified location (Step S12). In this case, the monitoring unit 32 may further specify the action that the target to be monitored has taken in the above-specified location based on the pattern that the return light has.

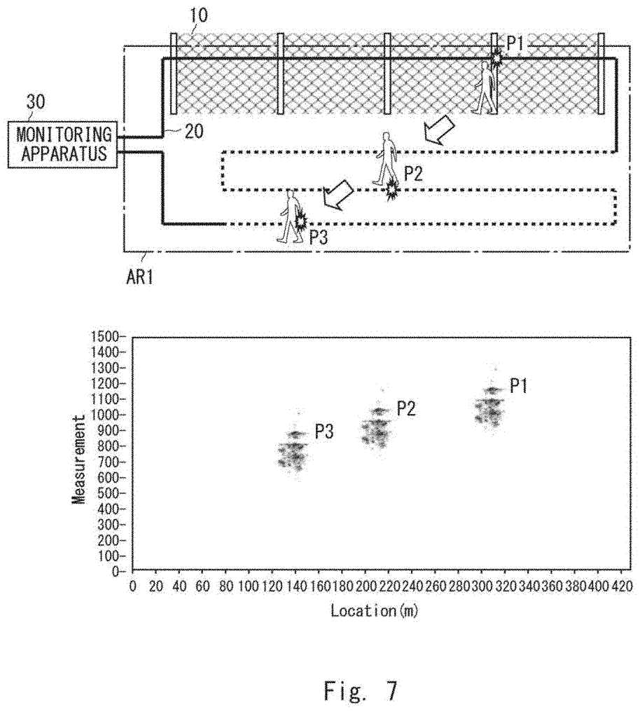

In the following description, with reference to FIG. 7, specific operations of the monitoring unit 32 according to the first embodiment will be explained. FIG. 7 is an example in which the target to be monitored is tracked based on the vibration data.

In the example shown in FIG. 7, vibration patterns occur in a plurality of respective points (P1-P3). Therefore, the monitoring unit 32 detects the vibration patterns in the plurality of respective points (P1-P3), and specifies the trajectory of the target to be monitored based on the locational variations of the locations in which the vibration patterns have been detected. However, the method of specifying the trajectory is not limited thereto.

For example, the monitoring unit 32 may specify the trajectory of the target to be monitored by performing composite matching/analysis of the vibration patterns detected in the plurality of points (P1-P3). The composite matching/analysis includes, for example, processing of regarding the plurality of points (P1-P3) to be a series of patterns and matching the series of patterns with a model (e.g., a pattern indicating walking of a person).

Further, the monitoring unit 32 may analyze variations in the respective points, specify the unique pattern of the target to be monitored and tracked, and execute tracking while specifying the target to be monitored. In this case, the monitoring unit 32 may execute, for example, pattern matching in such a way that the unique pattern of the action of the person specified at the points P1 and P2 is detected at P3, whereby the monitoring unit 32 may specify that the vibration patterns detected at the points P1-P3 are the vibration patterns by one person and specify the moving trajectory.

Further, while the points P1-P3 are close to one another in the example shown in FIG. 7, it is possible, for example, that the point P3 is separated from the points P1 and P2 and continuous detection may not be performed. In this case, for example, the monitoring unit 32 may specify the moving direction, the moving speed and the like of the target to be monitored and predict and execute the pattern analysis at around the point P3 from the results of the detection at the points P1-P2. In this case, the monitoring unit 32 may specify the moving speed from the relation between the time when the point has been changed and a distance between the points.

### Effects of First Embodiment

As described above, according to this first embodiment, the monitoring apparatus 30 specifies the location of the target to be monitored based on the pattern in accordance with the state of the target to be monitored that the return light received from at least one optical fiber included in the optical fiber cable 20 has and specifies the trajectory of the target to be monitored based on the locational variation of the specified location. Therefore, the optical fiber cable 20 is laid down in the whole part of the monitoring area even when this is a wide monitoring area, whereby the target to be monitored can be continuously tracked. Further, the optical fiber cable 20 is inexpensive and can be easily laid down. Therefore, it is possible to construct the system capable of continuously tracking the target to be monitored easily for a low cost.

Further, according to this first embodiment, the monitoring apparatus 30 specifies the trajectory and the action taken by the target to be monitored based on the pattern that the return light has. This tracking based on the pattern detection has the following advantages over the tracking based on the camera image.
The trajectory and the action of the target to be monitored in a blind spot point of a camera such as an area behind an object can be tracked without interruption.
It is possible to track the trajectory and the action of the target to be monitored even in a case in which halation occurs in the camera and the target to be monitored is not on the camera image.
It is also possible to track the trajectory and the action of the target to be monitored who is taking an action that is not captured by a camera (e.g., hiding a face, moving to a blind spot point of a camera).

Further, according to this first embodiment, as described above, the monitoring apparatus 30 specifies the action that the target to be monitored has taken based on the pattern that the return light has. That is, instead of specifying, for example, the action based on a rough reference such as whether the magnitude of a vibration is large or small (e.g., the action is specified from results that the vibration is large and the number of vibrations is large), the monitoring apparatus 30 dynamically analyzes the pattern of the change of the return light (e.g., transition of a change in the magnitude of the vibration), thereby specifying the action of the target to be monitored. It is therefore possible to specify the action of the target to be monitored with a high accuracy.

Further, according to the first embodiment, the optical fiber sensing technology that uses the optical fibers as sensors is used. Therefore, it is possible to obtain advantages that there is no influence of electromagnetic noise, power feeding to the sensors becomes unnecessary, environmental tolerance is high, and a maintenance operation can be easily performed.

### Second Embodiment

### <Configuration of Second Embodiment>

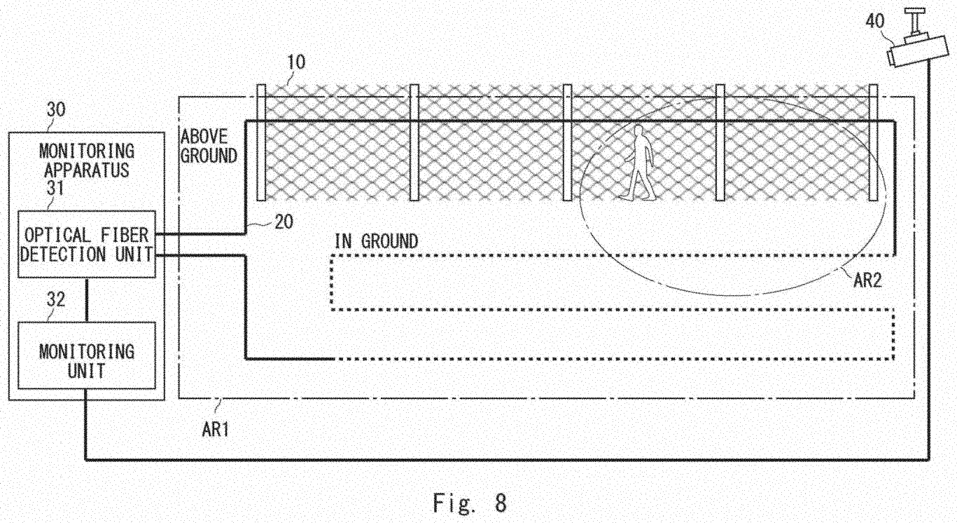

Referring next to FIG. 8, a configuration of an optical fiber sensing system according to a second embodiment will be explained. While the description will be made assuming that the targets to be monitored are persons who are in the fence 10 and in the vicinity thereof in this second embodiment as well, similar to the aforementioned first embodiment, the target to be monitored is not limited to them.

As shown in FIG. 8, the optical fiber sensing system according to the second embodiment further includes a camera 40 in addition to the components of the aforementioned first embodiment. While only one camera 40 is provided in FIG. 8, a plurality of cameras 40 may be provided.

The camera 40, which captures images of the fence 10 and the vicinity thereof, is achieved by, for example, a fixed camera, a Pan Tilt Zoom (PTZ) camera or the like. Note that, in FIG. 8, an image-capturable area AR2 that can be captured by the camera 40 is included inside the optical fiber sensing area AR1. However, the relation between the optical fiber sensing area AR1 and the image-capturable area AR2 is not limited thereto. The image-capturable area AR2 may be arranged in such a way that it is adjacent to the optical fiber sensing area AR1 or a part of the image-capturable area AR2 may overlap the optical fiber sensing area AR1.

The monitoring unit 32 holds camera information indicating the location in which the camera 40 is installed (distance from the optical fiber detection unit 31, the latitude and the longitude of the location in which the camera 40 is installed etc.), the location that defines the image-capturable area (latitude, longitude and the like) etc. Further, as described above, the monitoring unit 32 is able to specify the location of the target to be monitored based on the pattern that the return light received in the optical fiber detection unit 31 has. Therefore, the monitoring unit 32 controls the camera 40 when it has been detected that the target to be monitored is present inside the image-capturable area AR2. The monitoring unit 32 controls, for example, the angle (azimuth angle, elevation angle) of the camera 40, zoom magnification and the like.

Therefore, when the target to be monitored is present inside the image-capturable area AR2, the monitoring unit 32 is also able to perform image recognition of the camera image captured by the camera 40, specify the location of the target to be monitored, and specify the trajectory of the target to be monitored based on a locational variation of the specified location. Further, the monitoring unit 32 is also able to perform image recognition of the camera image, specify the action of the target to be monitored, and perform face recognition of the target to be monitored on the camera image.

In the following description, an example in which the monitoring unit 32 tracks the target to be monitored in the second embodiment will be explained in detail. It is assumed, in the following description, that the tracking based on the camera image or the tracking of the target to be monitored based on the camera image mean that the trajectory and the action of the target to be monitored are specified based on the camera image captured by the camera 40. It is further assumed that the tracking based on the pattern detection or the tracking of the target to be monitored based on the pattern detection mean that the trajectory and the action of the target to be monitored are specified based on the pattern that the return light received in the optical fiber detection unit 31 has. The monitoring unit 32 may allocate, for example, a specific ID for each target to be monitored that has been detected, associate information on the location of this target to be monitored with the ID of the target to be monitored, and store this information in time series, thereby recording the trajectory of the target to be monitored.

### (1) First Example

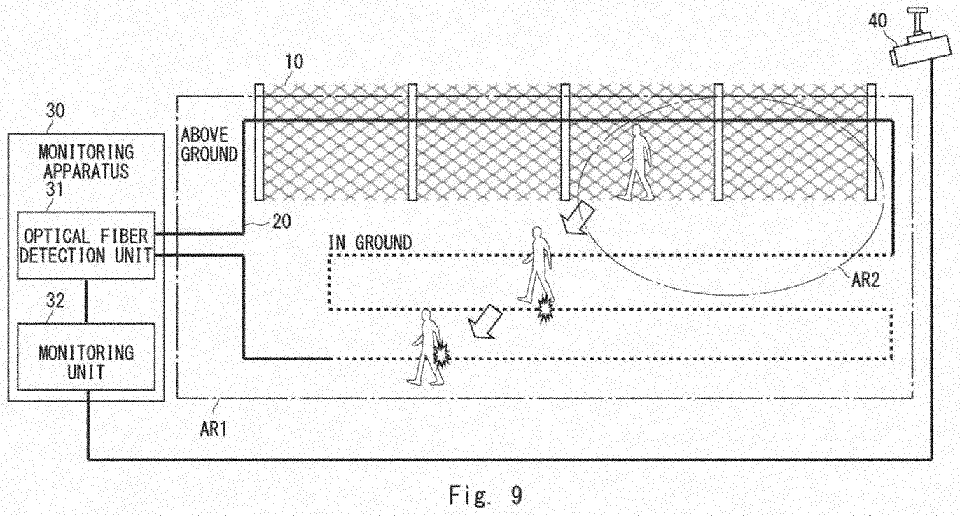

As shown in FIG. 9, this example is an example in which the target to be monitored goes outside of the image-capturable area AR2 from inside the image-capturable area AR2.

The monitoring unit 32 performs tracking of the target to be monitored based on the camera image when the target to be monitored is inside the image-capturable area AR2. At this time, the monitoring unit 32 may track only a specific person who is inside the image-capturable area AR2 as the target to be monitored. The tracking of the target to be monitored may be started, for example, when one of the following cases occurs.
A person who is on the camera image coincides with a person who is on a blacklist (coincidence by face recognition, whole body authentication, gait authentication etc.)
A person who is on the camera image is taking a predetermined action (wobbling, hanging around, staying in one place for equal to or more than a predetermined period of time, swinging around something, approaching the fence 10 etc.)
A person who is on the camera image wears specific clothes or carries specific belongings.

When the target to be monitored goes outside of the image-capturable area AR2 from inside the image-capturable area AR2, the monitoring unit 32 switches the tracking of the target to be monitored from tracking based on the camera image to tracking based on the pattern detection. The monitoring unit 32 switches, for example, for the ID of one target to be monitored, recording of the information on the location specified from the camera image to recording of the information on the location specified by the pattern detection. At this time, the monitoring unit 32 may be ready to perform image recognition on the camera image, predict the location in which the target to be monitored goes outside of the image-capturable area AR2, and promptly start tracking based on the pattern detection starting from the predicted location. Further, the monitoring unit 32 may specify the location in which the target to be monitored has actually gone outside of the image-capturable area AR2, and start performing tracking based on the pattern detection starting from the specified location. However, in order to set the location specified in the camera image as the starting point of the tracking based on the pattern detection, processing of converting the location on the camera image into the location on the fiber sensor needs to be performed. In order to achieve this processing, the monitoring unit 32 may hold, for example, a table in which the camera coordinates and the coordinates of the fiber sensor are associated with each other in advance and perform the aforementioned positional conversion using this table. Further, the monitoring unit 32 may hold, in advance, two tables, i.e., a table in which the camera coordinates and the world coordinates are associated with each other and a table in which the world coordinates and the coordinates of the fiber sensor are associated with each other, and perform the aforementioned positional conversion using the two tables. The monitoring unit 32 switches the tracking based on the camera image to the tracking based on the pattern detection and continuously tracks the target to be monitored using the aforementioned tables.

When the target to be monitored is inside the image-capturable area AR2, the monitoring unit 32 may perform tracking of the target to be monitored based on the pattern detection simultaneously with the tracking of the target to be monitored based on the camera image. For example, the trajectory of the target to be monitored may be specified by the tracking based on the camera image and the action of the target to be monitored may be specified by the tracking based on the pattern detection. Further, the location and the trajectory of the target to be monitored may be specified by both the tracking based on the camera image and the tracking based on the pattern detection, and both the information on the location specified by the tracking based on the camera image and the information on the location specified by the tracking based on the pattern detection may be recorded.

Further, the monitoring unit 32 may change the control of the camera 40 in accordance with the action of the target to be monitored when the tracking of the target to be monitored based on the pattern detection is performed simultaneously with the tracking of the target to be monitored based on the camera image is performed. When, for example, a suspicious action that is required to be dealt with more immediately (e.g., digging a hole in the vicinity of the fence 10, climbing the fence 10 etc.) has been specified, the monitoring unit 32 may zoom in the camera 40 so as to specify the face and the person in more detail. Further, when the suspicious action that is required to be dealt with more immediately has been specified, if the image-capturable area AR2 can be captured by a plurality of cameras 40, the monitoring unit 32 may track the target to be monitored by the plurality of cameras 40. Further, the monitoring unit 32 may cause, when the target to be monitored is tracked by the plurality of cameras 40, at least one of the plurality of cameras 40 to capture an image of the face of the target to be monitored, thereby utilizing the captured face image for face recognition, and may cause at least one of the plurality of cameras 40 to capture an image of the whole part of the image-capturable area AR2, thereby utilizing the captured image for monitoring of the action of the target to be monitored.

### (2) Second Example

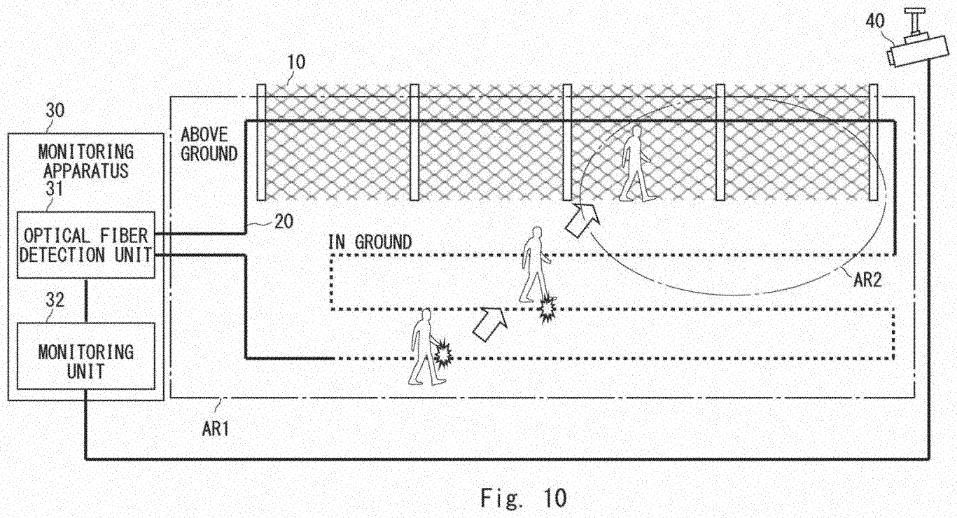

As shown in FIG. 10, this example is the one in which the target to be monitored enters the image-capturable area AR2 from the outside of the image-capturable area AR2.

The monitoring unit 32 performs tracking of the target to be monitored based on the pattern detection when the target to be monitored is present outside of the image-capturable area AR2. At this time, the monitoring unit 32 may track only a specific person who is outside of the image-capturable area AR2 as the target to be monitored. The tracking of the target to be monitored may be started, for example, when the persons who are in the fence 10 and in the vicinity thereof have taken one of the aforementioned actions (1)-(8).

When the target to be monitored enters the image-capturable area AR2 from the outside thereof, the monitoring unit 32 switches the tracking of the target to be monitored from the tracking based on the pattern detection to the tracking based on the camera image. The monitoring unit 32 switches, for example, for the ID of one target to be monitored, recording of the information on the location specified by the pattern detection to recording of the information on the location specified from the camera image. At this time, when it is detected, by the tracking based on the pattern detection, that the target to be monitored has approached the image-capturable area AR2, the monitoring unit 32 specifies the direction in which the target to be monitored is present and may further perform control such as pointing the camera in the specified direction and zooming in the camera. Further, the monitoring unit 32 may specify the location in which the target to be monitored has actually entered the image-capturable area AR2, and start the tracking based on the camera image starting from the specified location. However, in order to set the location specified in the pattern detection as the starting point of the tracking based on the camera image, processing of converting the location on the fiber sensor into the location on the camera image needs to be performed. The monitoring unit 32 may hold, for example, a table similar to the table described in the aforementioned first example in advance and perform the aforementioned positional conversion using this table. The monitoring unit 32 switches the tracking based on the pattern detection to the tracking based on the camera image and continuously track the target to be monitored by using the aforementioned table.

The monitoring unit 32 may perform tracking of the target to be monitored based on the pattern detection simultaneously with the tracking of the target to be monitored based on the camera image when the target to be monitored is inside the image-capturable area AR2, similar to that in the aforementioned first example. The specific example in this case is similar to that in the aforementioned first example.

### (3) Third Example

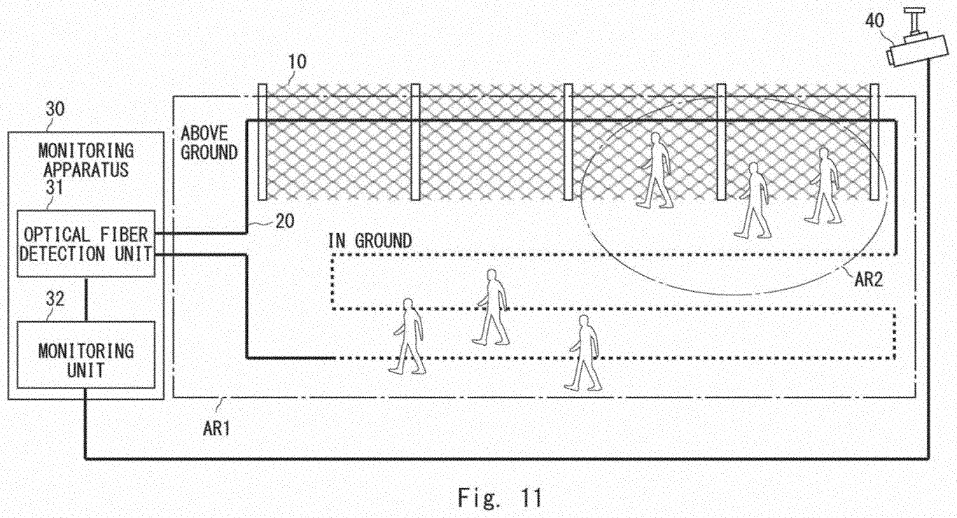

As shown in FIG. 11, this example is the one in which there are a plurality of persons inside the optical fiber sensing area AR1 or inside the image-capturable area AR2.

When there are a plurality of persons, the monitoring unit 32 may regard only a specific person to be the target to be monitored instead of regarding all the plurality of persons to be the targets to be monitored.

When, for example, there are a plurality of persons inside the image-capturable area AR2 and the following phenomenon has been detected for one of the plurality of persons, the monitoring unit 32 may determine this person to be the target to be monitored.
A person who is on the camera image coincides with a person who is on a blacklist (coincidence by face recognition, whole body authentication, gait authentication etc.)
A person who is on the camera image is taking a predetermined action (wobbling, hanging around, staying in one place for equal to or more than a predetermined period of time, swinging around something, approaching the fence 10 etc.)
A person who is on the camera image wears specific clothes or carries specific belongings.

In this case, in the following processes, the monitoring unit 32 tracks only the person who is determined to be the target to be monitored by the tracking based on the pattern detection and the tracking based on the camera image. Further, the monitoring unit 32 may learn the pattern of the vibration data or the like when the person who is determined to be the target to be monitored has taken some action as a pattern of unsuspicious behavior (e.g., walking direction, waling speed, stride length, or sound of footsteps).

Further, when there are a plurality of persons inside the optical fiber sensing area AR1, the monitoring unit 32 may specify the action for each of the plurality of persons and determine the target to be monitored from among the plurality of persons based on the actions of the plurality of respective persons.

The monitoring unit 32 may determine, for example, the person who is acting suspiciously to be the target to be monitored. In this case, in the following processes, the monitoring unit 32 tracks only the person who has been determined to be the target to be monitored by the tracking based on the pattern detection and the tracking based on the camera image. Further, the aforementioned suspicious behavior may be an action in which a plurality of actions are combined with each other (e.g., putting something after hanging around the fence 10). Further, the monitoring unit 32 may control, when the person who is determined to be the target to be monitored enters the image-capturable area AR2, the direction, zoom, exposure and the like of the camera 40 so as to capture an image of the face of this person, and may add this person in the aforementioned blacklist.

### <Operations of Second Embodiment>

In the following description, with reference to FIG. 12, an operation flow of the optical fiber sensing system according to the second embodiment will be explained. FIG. 12 is an example of a case in which only the tracking based on the camera image is performed and the tracking based on the pattern detection is not performed when the target to be monitored is inside the image-capturable area AR2.

As shown in FIG. 12, first, the optical fiber detection unit 31 emits the pulsed light to at least one optical fiber included in the optical fiber cable 20 and receives the return light having a pattern in accordance with the states of the targets to be monitored who are in the fence 10 and in the vicinity thereof from the optical fiber the same as the optical fiber to which the pulsed light has been emitted (Step S21).

Next, the monitoring unit 32 determines whether the target to be monitored is present inside the image-capturable area AR2 (Step S22).

When the target to be monitored is present inside the image-capturable area AR2 (Yes in Step S22), the monitoring unit 32 then specifies the location of the target to be monitored based on the camera image captured by the camera 40 and specifies the trajectory of the target to be monitored based on the locational variation of the specified location (Step S23). In this case, the monitoring unit 32 may specify the action that the target to be monitored has taken in the above-specified location based on the camera image.

On the other hand, when the target to be monitored is not present inside the image-capturable area AR2 (No in Step S22), the monitoring unit 32 then specifies the location of the target to be monitored based on the pattern that the return light has and specifies the trajectory of the target to be monitored based on the locational variation of the specified location (Step S24). In this case, the monitoring unit 32 may specify the action that the target to be monitored has taken in the above-specified location based on the pattern that the return light has.

### <Effects of Second Embodiment>

As described above, according to this second embodiment, the monitoring apparatus 30 specifies the trajectory of the target to be monitored based on the pattern in accordance with the state of the target to be monitored that the return light received from at least one optical fiber included in the optical fiber cable 20 has and the camera image captured by the camera 40. In this way, by linking the pattern detection that the return light has and the camera image, the monitoring and the tracking of the target to be monitored can be performed with a higher accuracy.

Further, the tracking based on the camera image has the following advantages over the tracking based on the pattern detection.
The trajectory and the action of the target to be monitored in the point in which the optical fiber cable 20 is not laid down can be tracked without interruption. Image analysis (face detection, face recognition etc.) of the target to be monitored can be performed.
Actions that do not involve contact with the fibers (delivery and receipt of a package, swinging around something etc.) can be detected.

Further, in an area in which the area where the optical fiber cable 20 is laid down and the area that can be captured by the camera 40 overlap each other (the aforementioned image-capturable area AR2), the tracking based on the camera image and the tracking based on the pattern detection can be concurrently performed. In this case, for example, the tracking based on the camera image is performed in the point in which the optical fiber cable 20 is not laid down and the tracking based on the pattern detection is performed in a blind spot point of the camera 40, whereby it is possible to perform monitoring and tracking of the target to be monitored while maintaining the advantages of both tracking operations.

Further, one phenomenon may be detected by integrating the result of the tracking based on the camera image and the result of the tracking based on the pattern detection. The following phenomenon may be, for example, detected.
A person who is on the blacklist is detected in the tracking based on the camera image and it is detected that this person is hitting the fence 10 in the tracking based on the pattern detection.
It is detected, in both the tracking based on the camera image and the tracking based on the pattern detection, that the target to be monitored is digging a hole. In this case, it can be considered that it is highly likely that the target to be monitored is digging a hole.

### Third Embodiment

### <Configuration of Third Embodiment>

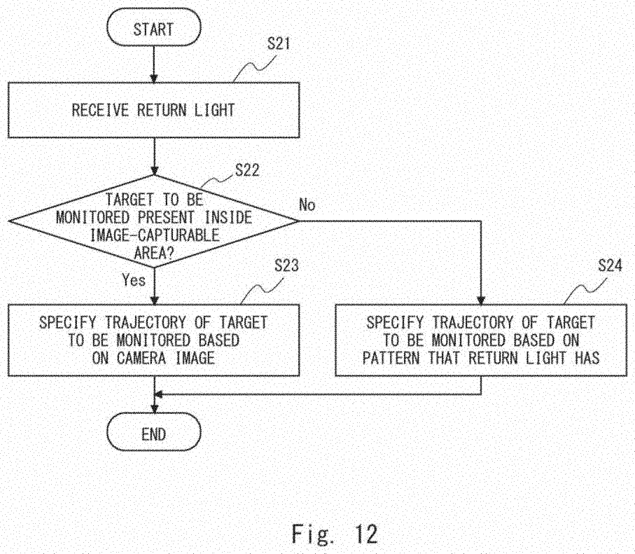

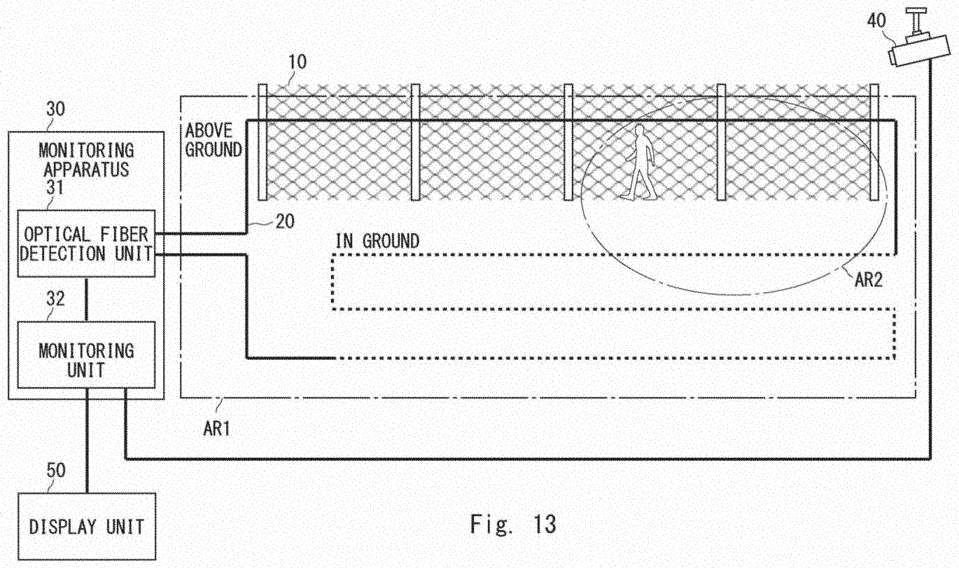

First, with reference to FIG. 13, a configuration of an optical fiber sensing system according to a third embodiment will be explained. While the description will be made assuming that the targets to be monitored are persons who are in the fence 10 and in the vicinity thereof in this third embodiment as well, similar to the aforementioned first and second embodiments, the target to be monitored is not limited to them.

As shown in FIG. 13, the optical fiber sensing system according to the third embodiment further includes a display unit 50 in addition to the components of the aforementioned second embodiment.

The display unit 50, which displays the results of tracking the target to be monitored by the monitoring unit 32, is installed in a monitoring room or the like which monitors the fence 10 and the vicinity thereof. The display unit 50 may be connected, for example, to the input/output interface 604 of the computer 60 (computer that implements the monitoring apparatus 30) shown in FIG. 6 as the display device 6041 in FIG. 6.

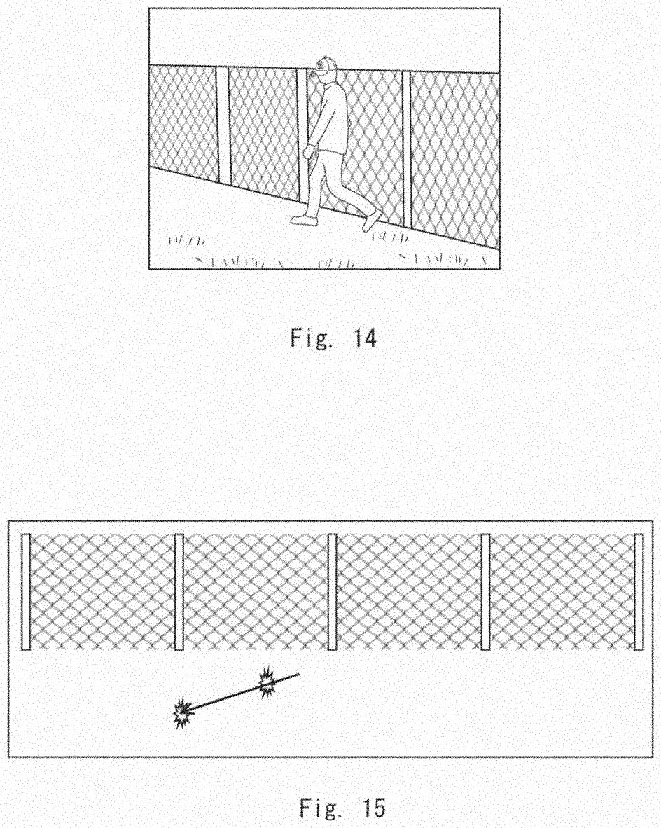

The display unit 50 displays, when the monitoring unit 32 is tracking the target to be monitored based on the camera image, the camera image captured by the camera 40, as shown in FIG. 14.

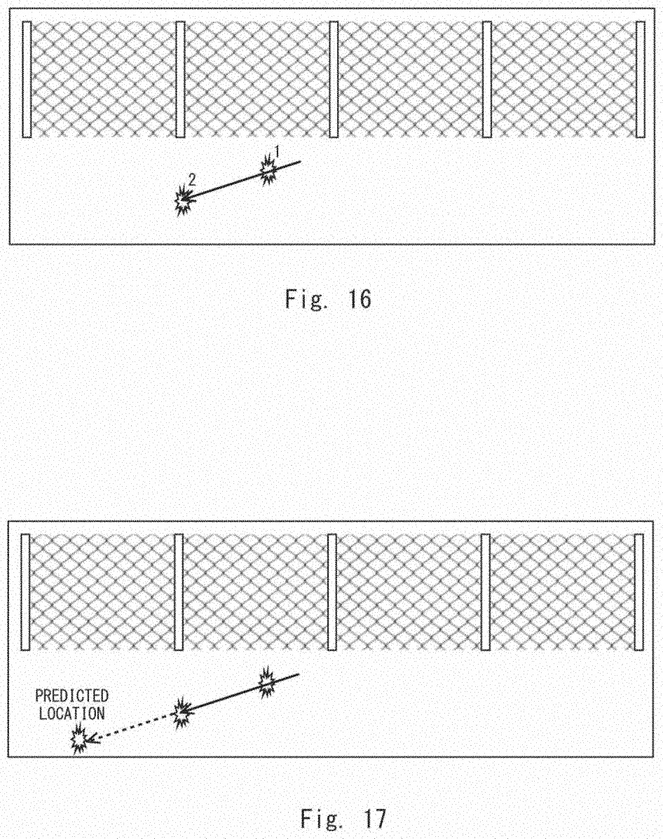

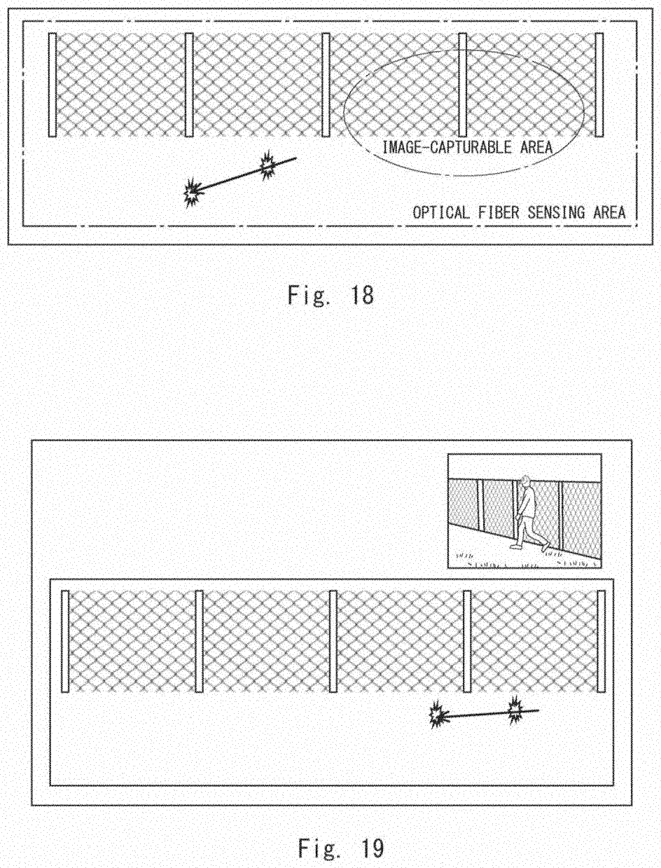

Further, the display unit 50 displays the image of the trajectory of the target to be monitored when the monitoring unit 32 is performing tracking of the target to be monitored based on the pattern detection. In this case, the display unit 50 may display the image of the trajectory of the target to be monitored on the map, or on the image which shows the optical fiber sensing area AR1 broadly. For example, the example shown in FIG. 15 is an example in which the image of the trajectory after the target to be monitored shown in FIG. 9 has gone outside of the image-capturable area AR2 is displayed on an image which shows the optical fiber sensing area AR1 broadly. Further, the marks shown in FIG. 15 indicate the specified locations of the target to be monitored. Further, the display unit 50 may add, as shown in FIG. 16, for example, numbers indicating the order in which the locations have been specified to the marks so that the time series can be seen. Further, when the monitoring unit 32 has predicted the location to which the target to be monitored will move next, the display unit 50 may display the next predicted location of the target to be monitored as shown in, for example, FIG. 17. Further, the display unit 50 may display the image of the optical fiber sensing area AR1 and the image of the image-capturable area AR2 as shown in, for example, FIG. 18.

Further, when the target to be monitored is inside the image-capturable area AR2 and the monitoring unit 32 concurrently performs the tracking based on the camera image and the tracking based on the pattern detection, the display unit 50 may display the camera image captured by the camera 40 and the image of the trajectory of the target to be monitored that has been obtained in the tracking based on the pattern detection at the same time, as shown in, for example, FIG. 19. The positional relation between the camera image and the image of the trajectory of the target to be monitored shown in FIG. 19 is merely one example and it is not limited thereto. Further, the display unit 50 may first display only the image of the trajectory of the target to be monitored. Then, when the location of the target to be monitored is, for example, clicked, on the image of the trajectory, the display unit 50 may display a camera image of the target to be monitored at this time by a pop-up image or the like.

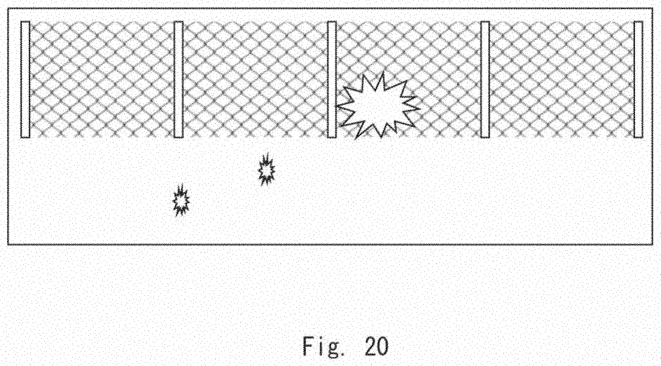

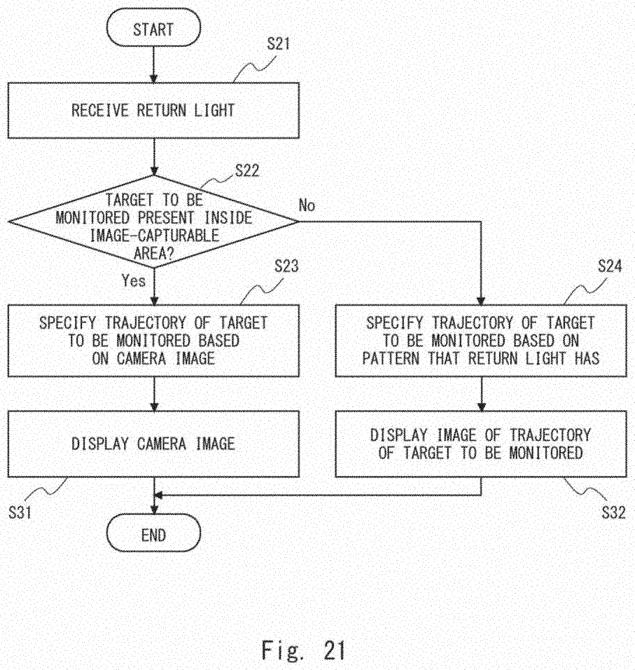

Further, when there are a plurality of persons inside the optical fiber sensing area AR1, before the target to be monitored is determined from among the plurality of persons, the display unit 50 may display locations of the plurality of respective persons who are inside the optical fiber sensing area AR1 by marks. In this case, when there is a person who has acted suspiciously, the display unit 50 may display the mark of the person who has acted suspiciously in such a way that this mark becomes more noticeable than the other marks. As shown in FIG. 20, for example, the display unit 50 may display the mark of the person who has acted suspiciously in such a way that this mark becomes larger than the other marks. Further, when there is a person who has acted suspiciously, the display unit 50 may display alarm information by a pop-up image or the like.

### <Operations of Third Embodiment>

In the following description, with reference to FIG. 21, an operation flow of the optical fiber sensing system according to the third embodiment will be explained. FIG. 21 shows an example of a case in which only the tracking based on the camera image is performed and the tracking based on the pattern detection is not performed when the target to be monitored is inside the image-capturable area AR2.

As shown in FIG. 21, first, processing of Steps S21-S22 described with reference to FIG. 12 in the aforementioned second embodiment is performed.

After that, when the processing of Step S23 described in FIG. 12 (tracking based on the camera image) has been performed, the display unit 50 then displays the camera image captured by the camera 40 (Step S31).

On the other hand, when the processing of Step S24 (tracking based on the pattern) described with reference to FIG. 12 has been performed, the display unit 50 then displays the image of the trajectory of the target to be monitored that has been obtained in the tracking based on the pattern detection (Step S32). In this case, as described above, the display unit 50 may display the image of the trajectory of the target to be monitored on the map, or on the image which shows the optical fiber sensing area AR1 broadly. Further, the display unit 50 may add numbers indicating the order in which the locations have been specified to the marks. Further, the display unit 50 may further display the next predicted location of the target to be monitored. Further, the display unit 50 may further display the image of the optical fiber sensing area AR1 and the image of the image-capturable area AR2.

### <Effects of Third Embodiment>

As described above, according to the third embodiment, the display unit 50 displays the camera image captured by the camera 40 and the image of the trajectory of the target to be monitored that has been specified by the monitoring unit 32. Accordingly, a monitoring person or the like who is in a monitoring room or the like is able to visually and efficiently determine the trajectory of the target to be monitored based on the content displayed on the display unit 50.

While the present disclosure has been described with reference to the embodiments, the present disclosure is not limited to the aforementioned embodiments. Various changes that can be understood by those skilled in the art can be made to the configurations and the details of the present disclosure within the scope of the present disclosure.

For example, while the example in which the targets to be monitored are persons who are in the fence and a place in the vicinity of the fence has been described in the aforementioned embodiments, the target to be monitored is not limited thereto. The target to be monitored may be a person who is on a wall, a floor, a pipeline, a utility pole, a civil engineering structure, a road, a railroad, and a place in the vicinity thereof, not a person who is in the fence. Further, the fence, the wall and the like may be installed in a commercial facility, an airport, a border, a hospital, a city, a port, a plant, a nursing care facility, an office building, a nursery center, or at home. Further, the target to be monitored may be an animal, an automobile or the like, not a person.

While the monitoring apparatus 30 includes the optical fiber detection unit 31 and the monitoring unit 32 in the aforementioned embodiments, it is not limited thereto. The optical fiber detection unit 31 and the monitoring unit 32 may be achieved by devices different from each other.

A part or all of the aforementioned embodiments may be described as shown in the following Supplementary Notes. However, they are not limited thereto.

(Supplementary Note 1)

An optical fiber sensing system comprising:

a cable including optical fibers;

a reception unit configured to receive, from at least one optical fiber included in the cable, an optical signal having a pattern in accordance with a state of a target to be monitored; and

a monitoring unit configured to specify the location of the target to be monitored based on the pattern that the optical signal has and specify the trajectory of the target to be monitored based on a locational variation of the specified location.

(Supplementary Note 2)

The optical fiber sensing system according to Supplementary Note 1, wherein the monitoring unit specifies an action of the target to be monitored based on the pattern that the optical signal has.

(Supplementary Note 3)

The optical fiber sensing system according to Supplementary Note 2, further comprising a camera capable of capturing an image of the target to be monitored,

wherein the monitoring unit specifies the location of the target to be monitored based on the pattern that the optical signal has and a camera image captured by the camera and specifies the trajectory of the target to be monitored based on a locational variation of the specified location.

(Supplementary Note 4)

The optical fiber sensing system according to Supplementary Note 3, wherein

the monitoring unit specifies the trajectory of the target to be monitored based on the camera image when the target to be monitored is present inside an image-capturable area of the camera, and

the monitoring unit specifies the trajectory of the target to be monitored based on the pattern that the optical signal has when the target to be monitored is present outside of the image-capturable area.

(Supplementary Note 5)

The optical fiber sensing system according to Supplementary Note 3, wherein the monitoring unit specifies, when the target to be monitored is present inside the image-capturable area of the camera, the trajectory of the target to be monitored based on the camera image and specifies the action of the target to be monitored based on the pattern that the optical signal has.

(Supplementary Note 6)

The optical fiber sensing system according to any one of Supplementary Notes 3 to 5, wherein

the target to be monitored is a person, and

the monitoring unit specifies, when there are a plurality of persons, actions for the plurality of respective persons based on the pattern that the optical signal has, and determines the target to be monitored from among the plurality of persons based on the actions taken by the plurality of respective persons.

(Supplementary Note 7)

The optical fiber sensing system according to any one of Supplementary Notes 3 to 5, wherein

the target to be monitored is a person, and

the monitoring unit performs, when there are a plurality of persons, face recognition for each of the plurality of persons based on the camera image, and determines the target to be monitored from among the plurality of persons based on the result of the face recognition performed for each of the plurality of persons.

(Supplementary Note 8)

The optical fiber sensing system according to any one of Supplementary Notes 3 to 7, further comprising a display unit configured to display the camera image captured by the camera and display an image of a specified trajectory of the target to be monitored.

(Supplementary Note 9)

A monitoring apparatus comprising:

a reception unit configured to receive, from at least one optical fiber included in a cable, an optical signal having a pattern in accordance with a state of a target to be monitored; and

a monitoring unit configured to specify the location of the target to be monitored based on the pattern that the optical signal has and specify the trajectory of the target to be monitored based on a locational variation of the specified location.

(Supplementary Note 10)

The monitoring apparatus according to Supplementary Note 9, wherein the monitoring unit specifies an action of the target to be monitored based on the pattern that the optical signal has.

(Supplementary Note 11)

The monitoring apparatus according to Supplementary Note 10, wherein the monitoring unit specifies the location of the target to be monitored based on the pattern that the optical signal has and a camera image captured by a camera capable of capturing an image of the target to be monitored and specifies the trajectory of the target to be monitored based on a locational variation of the specified location.

(Supplementary Note 12)

The monitoring apparatus according to Supplementary Note 11, wherein

the monitoring unit specifies the trajectory of the target to be monitored based on the camera image when the target to be monitored is present inside an image-capturable area of the camera, and

the monitoring unit specifies the trajectory of the target to be monitored based on the pattern that the optical signal has when the target to be monitored is present outside of the image-capturable area.

(Supplementary Note 13)

The monitoring apparatus according to Supplementary Note 11, wherein the monitoring unit specifies, when the target to be monitored is present inside the image-capturable area of the camera, the trajectory of the target to be monitored based on the camera image and specifies the action of the target to be monitored based on the pattern that the optical signal has.

(Supplementary Note 14)

The monitoring apparatus according to any one of Supplementary Notes 11 to 13, wherein

the target to be monitored is a person, and

the monitoring unit specifies, when there are a plurality of persons, actions for the plurality of respective persons based on the pattern that the optical signal has, and determines the target to be monitored from among the plurality of persons based on the actions taken by the plurality of respective persons.

(Supplementary Note 15)

The monitoring apparatus according to any one of Supplementary Notes 11 to 13, wherein

the target to be monitored is a person, and

the monitoring unit performs, when there are a plurality of persons, face recognition for each of the plurality of persons based on the camera image, and determines the target to be monitored from among the plurality of persons based on the result of the face recognition performed for each of the plurality of persons.

(Supplementary Note 16)

A monitoring method by a monitoring apparatus, the monitoring method comprising:

receiving, from at least one optical fiber included in a cable, an optical signal having a pattern in accordance with a state of a target to be monitored; and

specifying the location of the target to be monitored based on the pattern that the optical signal has and specifying the trajectory of the target to be monitored based on a locational variation of the specified location.

(Supplementary Note 17)

A non-transitory computer readable medium storing a program for causing a computer to execute the following procedures of:

receiving, from at least one optical fiber included in a cable, an optical signal having a pattern in accordance with a state of a target to be monitored; and

specifying the location of the target to be monitored based on the pattern that the optical signal has and specifying the trajectory of the target to be monitored based on a locational variation of the specified location.

### REFERENCE SIGNS LIST

10 Fence
20 Optical Fiber Cable
30 Monitoring Apparatus
31 Optical Fiber Detection Unit
32 Monitoring Unit
40 Camera
50 Display Unit
60 Computer
601 Processor
602 Memory
603 Storage
604 Input/output Interface
6041 Display Device
6042 Input Device
605 Communication Interface

What is claimed is:

1. An optical fiber sensing system comprising:
a cable including optical fibers;
a reception unit configured to receive, from at least one optical fiber included in the cable, an optical signal having a pattern in accordance with a state of a target to be monitored; and
a monitoring unit configured to specify the location of the target to be monitored based on the pattern that the optical signal has and specify the trajectory of the target to be monitored based on a locational variation of the specified location.

2. The optical fiber sensing system according to claim 1, wherein the monitoring unit specifies an action of the target to be monitored based on the pattern that the optical signal has.

3. The optical fiber sensing system according to claim 2, further comprising a camera capable of capturing an image of the target to be monitored,
wherein the monitoring unit specifies the location of the target to be monitored based on the pattern that the optical signal has and a camera image captured by the camera and specifies the trajectory of the target to be monitored based on a locational variation of the specified location.

4. The optical fiber sensing system according to claim 3, wherein
the monitoring unit specifies the trajectory of the target to be monitored based on the camera image when the target to be monitored is present inside an image-capturable area of the camera, and
the monitoring unit specifies the trajectory of the target to be monitored based on the pattern that the optical signal has when the target to be monitored is present outside of the image-capturable area.

5. The optical fiber sensing system according to claim 3, wherein the monitoring unit specifies, when the target to be monitored is present inside the image-capturable area of the camera, the trajectory of the target to be monitored based on the camera image and specifies the action of the target to be monitored based on the pattern that the optical signal has.

6. The optical fiber sensing system according to claim 3, wherein
the target to be monitored is a person, and
the monitoring unit specifies, when there are a plurality of persons, actions for the plurality of respective persons based on the pattern that the optical signal has, and determines the target to be monitored from among the plurality of persons based on the actions taken by the plurality of respective persons.

7. The optical fiber sensing system according to claim 3, wherein
the target to be monitored is a person, and
the monitoring unit performs, when there are a plurality of persons, face recognition for each of the plurality of persons based on the camera image, and determines the target to be monitored from among the plurality of persons based on the result of the face recognition performed for each of the plurality of persons.

8. The optical fiber sensing system according to claim 3, further comprising a display unit configured to display the camera image captured by the camera and display an image of a specified trajectory of the target to be monitored.

9. A monitoring apparatus comprising:
a reception unit configured to receive, from at least one optical fiber included in a cable, an optical signal having a pattern in accordance with a state of a target to be monitored; and
a monitoring unit configured to specify the location of the target to be monitored based on the pattern that the optical signal has and specify the trajectory of the target to be monitored based on a locational variation of the specified location.

10. The monitoring apparatus according to claim 9, wherein the monitoring unit specifies an action of the target to be monitored based on the pattern that the optical signal has.

11. The monitoring apparatus according to claim 10, wherein the monitoring unit specifies the location of the target to be monitored based on the pattern that the optical signal has and a camera image captured by a camera capable of capturing an image of the target to be monitored and specifies the trajectory of the target to be monitored based on a locational variation of the specified location.

12. The monitoring apparatus according to claim 11, wherein
the monitoring unit specifies the trajectory of the target to be monitored based on the camera image when the target to be monitored is present inside an image-capturable area of the camera, and
the monitoring unit specifies the trajectory of the target to be monitored based on the pattern that the optical signal has when the target to be monitored is present outside of the image-capturable area.

13. The monitoring apparatus according to claim 11, wherein the monitoring unit specifies, when the target to be monitored is present inside the image-capturable area of the camera, the trajectory of the target to be monitored based on the camera image and specifies the action of the target to be monitored based on the pattern that the optical signal has.

14. The monitoring apparatus according to claim 11, wherein
the target to be monitored is a person, and
the monitoring unit specifies, when there are a plurality of persons, actions for the plurality of respective persons based on the pattern that the optical signal has, and determines the target to be monitored from among the plurality of persons based on the actions taken by the plurality of respective persons.

15. The monitoring apparatus according to claim 11, wherein
the target to be monitored is a person, and
the monitoring unit performs, when there are a plurality of persons, face recognition for each of the plurality of persons based on the camera image, and determines the target to be monitored from among the plurality of persons based on the result of the face recognition performed for each of the plurality of persons.

16. A monitoring method by a monitoring apparatus, the monitoring method comprising:
receiving, from at least one optical fiber included in a cable, an optical signal having a pattern in accordance with a state of a target to be monitored; and
specifying the location of the target to be monitored based on the pattern that the optical signal has and specifying the trajectory of the target to be monitored based on a locational variation of the specified location.

17. (canceled)
